(19) United States
(12) Patent Application Publication
(10) Pub. No.: US 2004/0117378 A1
(43) Pub. Date: Jun. 17, 2004

(54) Methods for accessing an information source

(76) Inventor: Sanjay Manandhar, Arlington, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/723,333

(22) Filed: Nov. 26, 2003

Related U.S. Application Data
(60) Provisional application No. 60/429,401, filed on Nov. 27, 2002.

(51) Int. Cl. G06F 17/30

(52) U.S. Cl. 707/10

(57) ABSTRACT

Information from publicly accessible information sources, such as electronic public displays, billboards, signs, and kiosks, is captured by a user device, obviating the need for individuals to make a mental note or write down the details from such sources. A publicly accessible information source having data items and a visible display is provided, the visible display presenting at least one data item. Upon viewing the display, an individual sends query data to the publicly accessible information source. Alternatively, upon the user's own pre-programming of his/her needs/requirements, the user device automatically queries various public displays for matching content. In response to the query data, the publicly accessible information source sends further data items to a user device. The source is capable of simultaneously servicing requests from a plurality of users in the vicinity of the source.

### CROSS-REFERENCE TO RELATED APPLICATIONS

The present application claims the benefit of and priority to co-pending provisional application No. 60/429,401, filed on Nov. 27, 2002, the entire disclosure of which is incorporated by reference as if set forth in its entirety herein.

### FIELD OF THE INVENTION

The present invention relates generally to information sources, and more specifically to accessing data from a publicly accessible information source.

### BACKGROUND OF THE INVENTION

The majority of publicly accessible information sources, such as billboards, signs, and kiosks, visually convey information to an audience. Upon viewing this information, members of the audience typically identify a pertinent portion of the information for later recall or use. However, a typical public information source makes note-taking or memorization the only practical means to record the pertinent information. This process may be cumbersome and inconvenient.

A need therefore exists for a system that allows users to automatically collect information from publicly accessible information sources.

### SUMMARY OF THE INVENTION

The present invention relates to the access of data from a publicly available information source. A user, programming requests into a user device, or upon viewing the display presented by an information source such as a billboard or electronic display, downloads data from the information source using the user device; the data may be accessed and used immediately or at a later time. For example, the downloaded data may be used to perform a commercial transaction with a vendor or to contact, e.g., a phone number or IP address provided by the information source. In accord with the principles of the present invention, the information source is capable of interacting with more than one user device simultaneously using wired or wireless communications.

In one aspect, therefore, the present invention provides a method for user access to a publicly accessible information source including the steps of providing a publicly accessible information source having data and an integrated visible display, sending query data to the publicly accessible information source upon viewing the integrated visible display or upon matching pre-programmed user requirements, and receiving publicly accessible information source data from the publicly accessible information source. The integrated visible display initially presents at least a first subset of the publicly accessible information source data, while the received data is at least a second subset of the publicly accessible information source data. Furthermore, the publicly accessible information source is simultaneously accessible to a plurality of users in the vicinity of the publicly accessible information source.

In one embodiment, the publicly accessible information source sends and receives data using a transceiver. This transceiver may communicate using a hardwired connection, infrared light, or radio frequency communications.

In some embodiments, the publicly accessible information source performs at least one of storing data, organizing data, and sorting data, using a database. The method may further include the step of negotiating with the publicly accessible information source to determine the content type of the data received. Moreover, the method may include the additional step of initiating a telephone call using the received second subset of data. In some embodiments, the method additionally includes the step of performing a commercial transaction using the received second subset of data.

In another aspect, the invention relates to a method for providing publicly accessible data to a user device comprising the steps of presenting at least a first subset of publicly accessible data using an integrated visible display, receiving query data from a user device after the presentation of the first subset of the publicly accessible data, and sending a second subset of the publicly accessible data to the user device in response to the query data. The queries of a plurality of users in the vicinity of the presented data are capable of being serviced simultaneously.

In embodiment, the user device sends and receives data using a transceiver. This transceiver may communicate using a hardwired connection, infrared light, or radio frequency communications.

In some embodiments, the user device performs at least one of storing data, organizing data, and sorting data, using a database. The method may further include the step of negotiating with the user device to determine the content type of the sent data. In some embodiments, the method further includes the step of negotiating with the user device to determine the capabilities of the user device.

The user device may be a personal digital assistant. In another embodiment, the user device is a cellular telephone.

In some embodiments, the method further includes the step of initiating a telephone call by the user device using the second subset of data. The method may include the additional step of performing a commercial transaction, by the user device using the second subset of data.

The foregoing and other features and advantages of the present invention will be made more apparent from the description, drawings, and claims that follow.

### BRIEF DESCRIPTION OF DRAWINGS

The advantages of the invention may be better understood by referring to the following drawings taken in conjunction with the accompanying description in which:

FIG. 1 schematically illustrates an embodiment of the present invention wherein a user device interacts with a publicly accessible information source through a communication channel;

FIG. 2 schematically depicts an exemplary interaction between the publicly accessible information source and the user device of FIG. 1;

FIG. 3 is a data flow diagram describing a typical data exchange between a publicly accessible information source and a user device in accord with one embodiment of the present invention;

FIG. 4 depicts one embodiment of a method for interaction between a user device and a publicly accessible information source in accord with the present invention; and

FIG. 5 depicts another embodiment of a method for interaction between a user device and a publicly accessible information source in accord with the present invention.

In the drawings, like reference characters generally refer to corresponding parts throughout the different views. The drawings are not necessarily to scale, emphasis instead being placed on the principles and concepts of the invention.

### DETAILED DESCRIPTION OF THE INVENTION

In brief overview, the present invention allows a user, by virtue of pre-programmed user requests or upon viewing the display presented by an information source such as a billboard or electronic display, to download data from the information source using a user device. The data downloaded to the user device may be the same data displayed on the display or it may be a subset of the displayed data. Alternatively, the data downloaded to the user device may be completely different from the data displayed by the information source.

The present invention allows the user to retain the data, once downloaded, in the user device for use at a later time. For example, the user may sort through similarly downloaded data or use the downloaded data to electronically perform a commercial transaction with a vendor or to contact a phone number or an IP address provided by the information source. The information source is capable of interacting with more than one user device simultaneously using wired or, more typically, wireless communications.

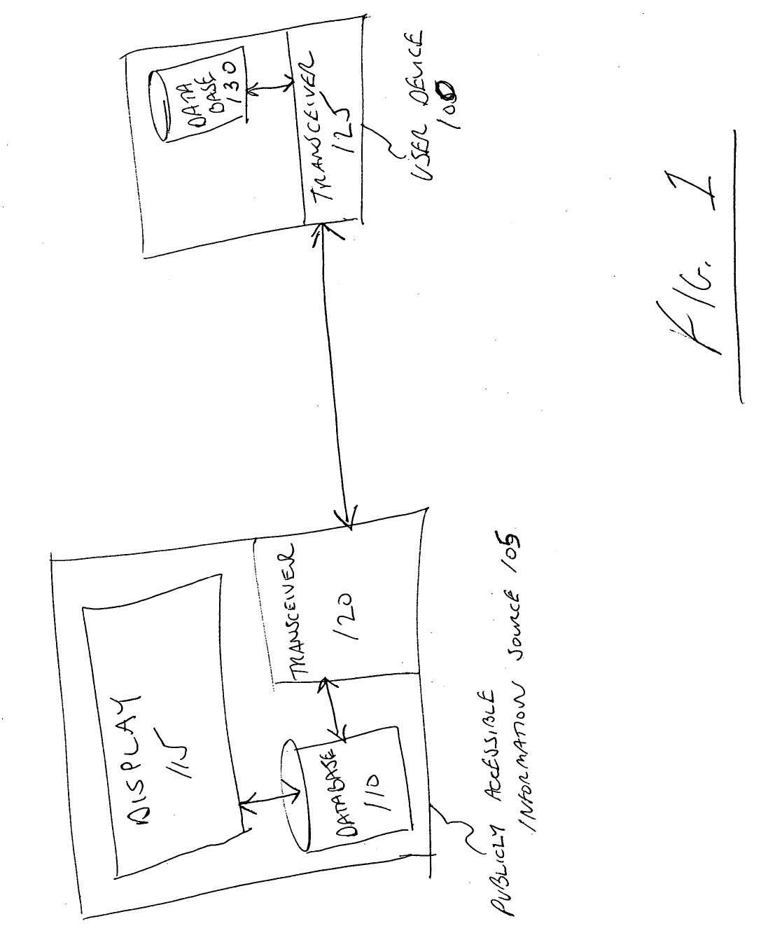

As illustrated in FIG. 1, in accord with the present invention a user device 100 interacts with a publicly accessible information source (“PAIS”) 105 through the exchange of data. Typical user devices 100 include a personal digital assistant (PDA), a mobile telephone, a laptop computer, an appropriately-modified headgear, clothing or wristwatch, or a device mounted inside an automobile. The PAIS 105 in various embodiments is a billboard, a sign, a kiosk, or any type of public display-static or dynamic. The user device 100 and the PAIS 105 communicate using transceivers employing various forms of wired and wireless communication. Exemplary forms of communication between the user device 100 and the PAIS 105 include communications over a serial cable using the RS-232 protocol, radio frequency communications (e.g., BLUETOOTH, 802.11x), other wireless communications, or communications using visible or invisible light (e.g., infrared light).

A PAIS 100 in accord with the present invention includes at least a database 110, a display 115, and a transceiver 120. In further embodiments, the PAIS includes one or more of a decorative encasing, speakers, and a time-sensitive content management and display system. The database 110 is implemented in a volatile or non-volatile memory and contains data items for display, for viewing by passersby, and for responding to queries from user devices. Typical data items in the database 110 includes advertisements, promotions, maps, directions, general information items, news items, fragments of games or competitions suitably played in a public forum and other items for public display. The database 110 may also contain status data, logging data, and schedule data controlling the display of data items. The display 115 is, in various embodiments, a paper or laminate structure, a cathode ray tube, a liquid crystal display, a plasma display, electronic ink display or any other suitable form of visual display.

The transceiver 120 provides communications between the PAIS 105 and one or more user devices 100. In some embodiments, the transceiver 120 also provides communications between the PAIS 105 and an administrative device controlling the operation of the PAIS 105 (not shown). The communications may be wired or wireless, and typically utilize at least one of a wired RS-232 serial cable, a radio frequency communication link (e.g., BLUETOOTH or 802.11x), another wireless communication link, or communications using visible or invisible light, such as infrared light.

In accord with the present invention, the user device 100 includes at least a transceiver 125 and a database 130. In other embodiments, the user device 100 includes at least one of a display, a data input mechanism (such as a keyboard or microphone), various I/O ports, and a speaker. Like the transceiver 120 of the PAIS 105, the transceiver 125 of the user device 100 provides communications between the user device 100 and the PAIS 105. The transceiver 125 may also provide communications between the user device 100 and, e.g., other user devices 100 (not shown). The database 130 on the user device 100 is implemented in a volatile or non-volatile memory and may be used to store, at a minimum, data items received from the PAIS 105. In some embodiments, the database 130 also stores logging data or status data. It should be understood that, particularly with regard to database 130, the term “database” broadly connotes any facility for storing data (e.g., a simple memory), and need not imply the ability to create data structures or support data fields.

In operation, the display 115 presents various data items selected from the database 110. As such, the display 115 may present data items forming all of, or a subset of, the data stored in the database 110. The display 115 may be refreshed periodically with the same data items or with different data items from the database 110. An individual, viewing the contents of the display 115, sees an interesting data item and wants to make note of the item for later review or use. The individual prompts the user device 100 to query the PAIS 105 for a data item related to the data item presented on the display 115. Alternatively, the user can program his/her needs and intentions into the user device (e.g. “I'm interested in all airfare promotions to London less than $200 that commence from now till the end of the month”) and allow the user device to automatically retrieve pertinent data from the various PAIS. In other words, the user specifies interest criteria, which are stored on the user device and employed by the device to determine whether to request data from displays. As the user device comes within communication range of a display equipped as described herein, the user device receives sufficient data from the display to determine whether the offering matches the user's criteria; if so, the user device downloads data from the display. Moreover, the user may further specify actions to be taken upon encountering specific types of data; for example, in response to some categories of offering, the user device may automatically download data; for other offerings, the user device may supply user data to the display, either automatically or upon user approval; and in still other cases, the user device may initiate a transaction (subject, ordinarily, to user approval).

Although this automatic downloading of data from PAIS is different from manual intervention to download data, it is important to note that the automatic download is still initiated and controlled by the user; ordinarily, user devices are not sent data autonomously by the PAIS. Optionally, the user device 100 and the PAIS 105 may negotiate their capabilities to determine whether the PAIS 105 may provide the displayed data item to the user device 100, or whether it must present another, related data item to the user device 100. For example, a PAIS 105 presenting a music video promoting a record album may provide that same advertisement to a video-equipped user device 100, or it may simply provide a text file containing the address of the nearest store selling the album and an electronic coupon good for a discount on the album's retail price. The user device 100 stores the received data item in its database 130 for later review or use. In accord with the principles of the present invention, the PAIS 105 is capable of receiving query data from a plurality of user devices 100 within the vicinity of the PAIS 105 or connected to the PAIS and servicing the plurality of queries substantially simultaneously.

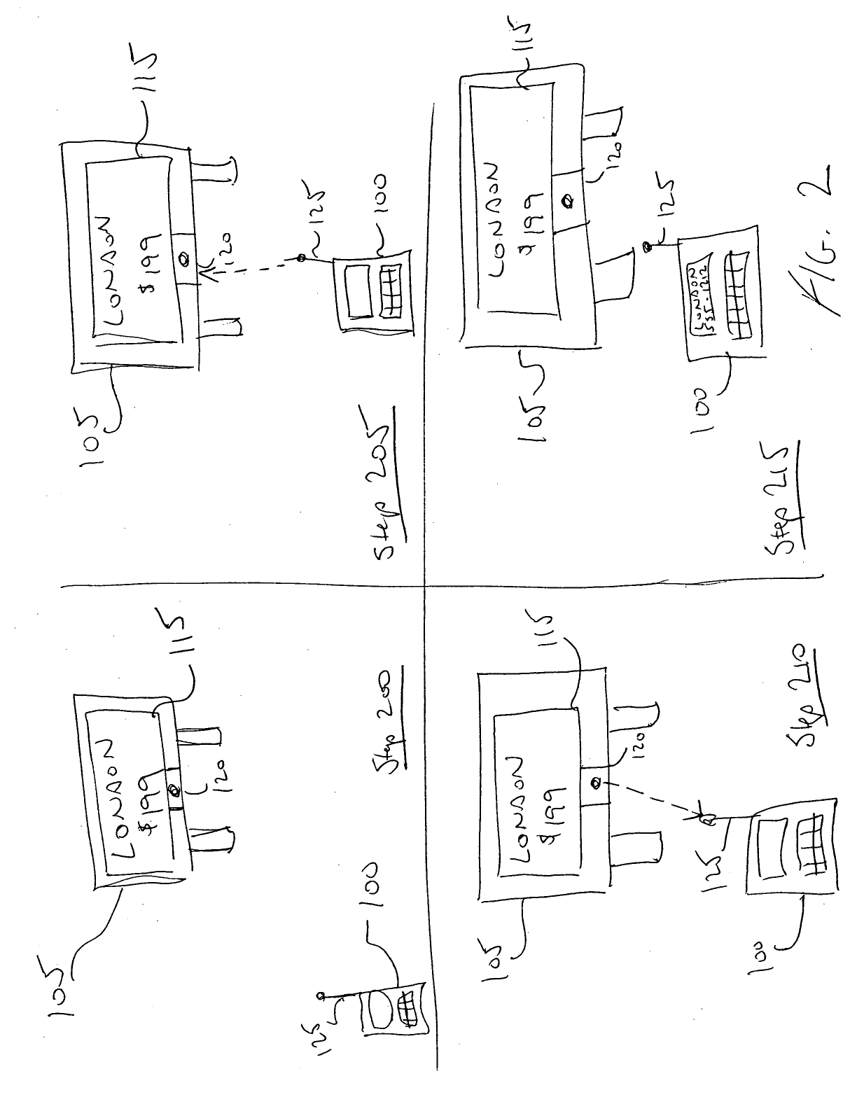

Another exemplary transaction between a user device 100 and a PAIS 105 is presented in FIG. 2. A user having a user device 100 enters within visual range of a PAIS 105 (Step 200). A data item advertising a round-trip fare to London for $199 is presented on the display 115 of the PAIS 105. The user sees the advertised fare on the PAIS 105 and decides to request more information. The user operates the user device 100 to send query data to the PAIS 105 through its transceiver 125 (Step 205), which the PAIS 105 receives through its transceiver 120. If the data meets the pre-programmed requirements, the query is done by the user device on behalf of the user if the user happens to be within the vicinity of the PAIS or connected to the PAIS in some way.

The PAIS 105 processes the received query data and determines an appropriate data item to send in response to the query. For example, as discussed above, the PAIS 105 may determine an appropriate data item based, in part, on the capabilities of the user device 100. Additionally, the PAIS 105 may select an appropriate data item for transmission based, for example, on the network capability or the data item currently displayed by the PAIS 105 and the time of day. Using its transceiver 120, the PAIS 105 sends the appropriate data item back to the user device 100 in response to the initial query (Step 210). The user device 100 receives the transmitted data item through its transceiver 125 and retains the data item locally, for example, displaying it on the user device 100 or storing it in memory for later review or use (Step 215). Again, it is contemplated that a plurality of individuals having user devices 100 will interact with the PAIS 105, and that the PAIS 105 will communicate with them substantially simultaneously.

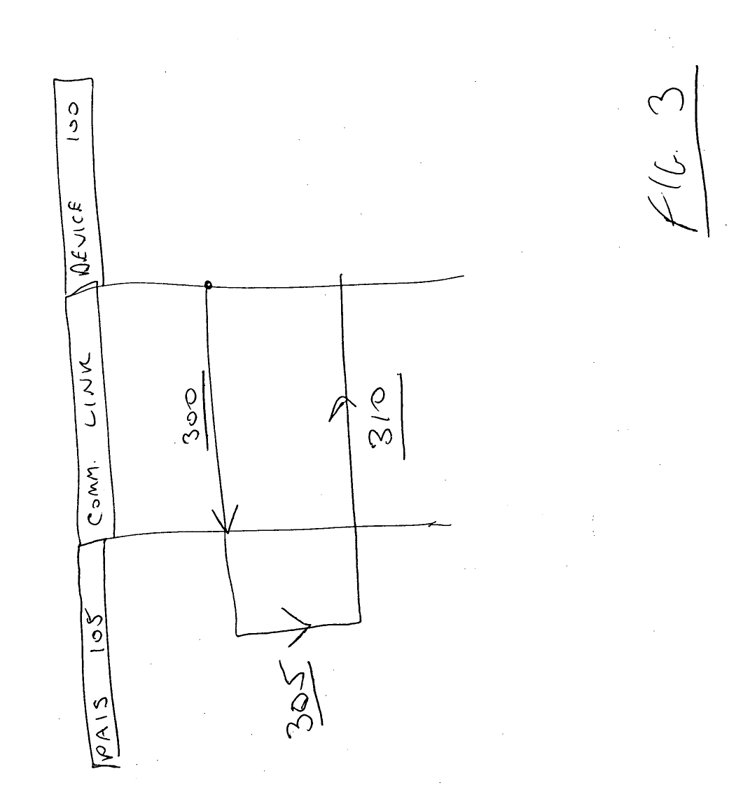

FIG. 3 is a data flow diagram describing the communications between a user device and a PAIS according to one embodiment of the present invention. A typical interaction between a user device and a PAIS begins with the user device sending query data to the PAIS over the communications link provided by their respective transceivers (Step 300). The PAIS receives the query data, accesses its database for an appropriate data item to send in response (Step 305) and sends the data item to the user device 100 (Step 310). The data item sent to the user device may be substantially identical to the data item displayed by the PAIS, it may be a subset of the displayed data item, or it may a data item that is entirely different from (although typically related in some way to) the data displayed by the PAIS. The communications between the user device and the PAIS may occur through wired or wireless means, such as a serial cable, a radio frequency communication link, or communications using visible or invisible light, such as infrared light.

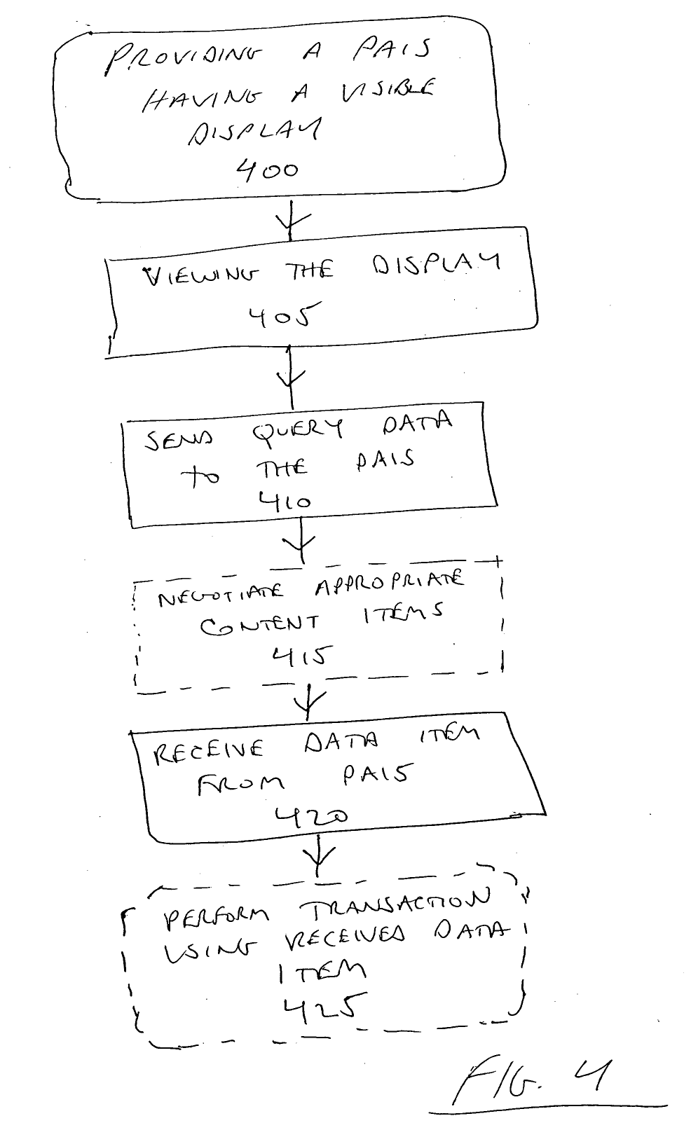

FIG. 4 is a flowchart describing the operation of an embodiment of the present invention as experienced by the operator of a user device. A PAIS having an integrated visible display is provided within view of an individual having a user device (Step 400). The PAIS presents, for example, either a single, static data item, or a sequence of changing, dynamic data items to passersby. The individual views the data item on the display of the PAIS (Step 405) and, when the information displayed is of interest to the individual, the individual downloads the information to the user device. Alternatively, the user device can act as a proxy to the user and download the data if pre-programmed desires of the user matches the data that the PAIS is putting out on public display.

To manually download information from the PAIS, the individual operates the user device to send query data to the PAIS so as to initiate the download process (Step 410). The user device and PAIS may optionally engage in a negotiation to determine appropriate time-of-day rules, allowed content rules, appropriate network capability, appropriate content types of the data items to be sent to the user device (Step 415). For example, the individual may prefer to download text data items instead of video or graphics data items. This negotiation process may also depend on the capabilities of the user device. For example, the user device might only be capable of reading certain file types and thus the negotiating process will ensure that the PAIS sends data in a format that is compatible with the user device.

Next, the user device receives at least one data item from the PAIS (Step 420). The received data may be in a format determined by the negotiation process. The received data is stored in memory for later use or used immediately to perform a transaction (Step 425). For example, a PAIS in one embodiment of the present invention may display an advertisement which reads, “Great Deal on Flight to London—$199.” Upon performing the method of FIG. 4, the user device will contain in its database several data items related to the advertisement, downloaded from the PAIS. Such information may include the name of the vendor offering this airline ticket sale price, the vendor's telephone number or other contact details such as a URL, or a script for automatically calling the vendor and charging the user's credit card account or personal vendor account for the ticket sale price. The user device may use the vendor's telephone number to initiate a phone call to the vendor at the user's request. Additionally, upon user request, the user device may use data downloaded from the PAIS to charge the user's account for the ticket sale price and request that the ticket information be sent to the user device for later use.

Similarly, the data transmitted by PAIS may include a uniform resource locator (URL), which may or may not be displayed on the PAIS, for a site on the World Wide Web. Where the user device is a PDA, for example, the user may operate the device to connect to the site specified by the URL, which may provide further information concerning the subject matter of the display and/or may permit the user to enter into a purchase transaction. Indeed, the transmitted data may include instructions which, when downloaded, cause the PDA to find the designated Web site automatically (i.e., without user prompting).

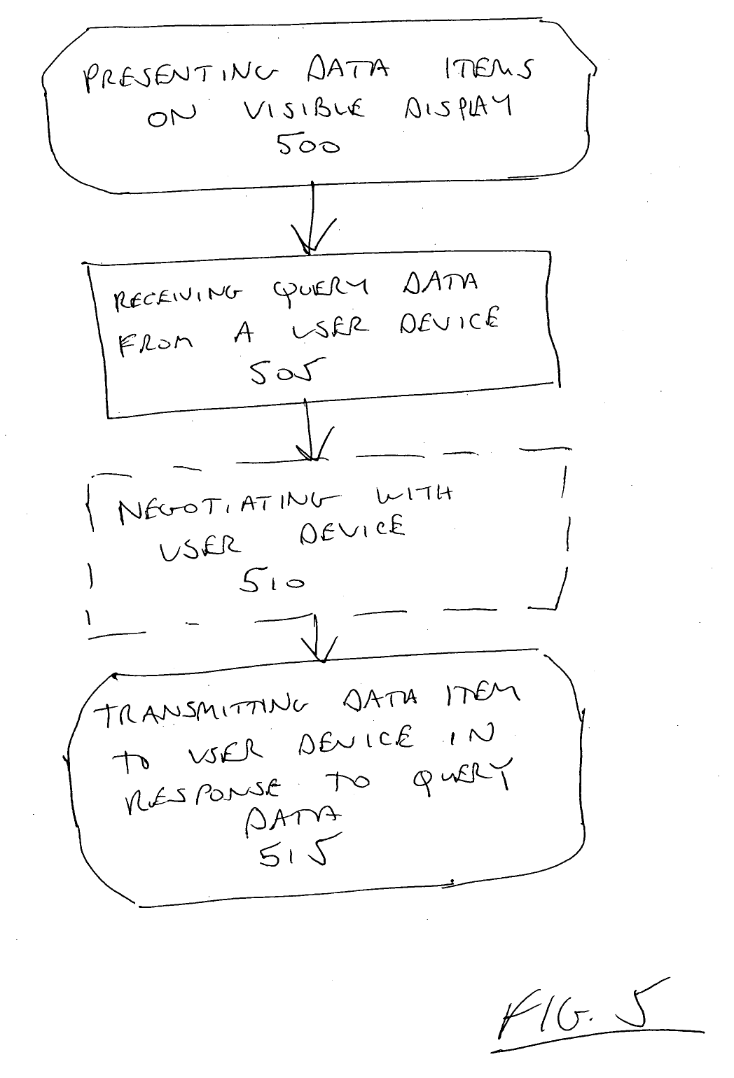

FIG. 5 is a flowchart describing the operation of an embodiment of the present invention as experienced by the PAIS. The PAIS displays data on its visible display (Step 500). The display is static or time-varying, as allowed by the form of the PAIS as well as any programming controlling the operation of the PAIS. Eventually the PAIS receives query data from a user device requesting that the PAIS send data to the user device that is related in some way to the data being displayed by the PAIS (Step 505). Before such data is sent to the user device, the PAIS may engage in an optional negotiating process with the user device to determine the appropriate network requirements, content and/or format of the data for transmission to the user device (Step 510). For example, the user may prefer to download only text data items and not video or graphics data items. The negotiating process may also be used to ensure that the PAIS sends data in a format that is suited to the capabilities of the user device. Lastly, the PAIS sends data to the user device in response to the query signal (Step 515). The transmitted data items may be substantially the same data items displayed by the PAIS, a subset of the displayed data items, or they may be completely different from the data items displayed by the PAIS. The PAIS may substantially simultaneously interact with a plurality of user devices within the vicinity of the PAIS.

Many alterations and modifications may be made by those having ordinary skill in the art without departing from the spirit and scope of the invention. Therefore, it must be expressly understood that the illustrated embodiments have been shown only for the purposes of example and should not be taken as limiting the invention, which is defined by the following claims. These claims are therefore to be read as including what they set forth literally and also those equivalent elements which are insubstantially different, even though not identical in other respects to what is shown and described in the above illustrations.

The present invention may also be provided as one or more computer-readable programs embodied on or in one or more articles of manufacture. The article of manufacture may be a floppy disk, a hard disk, a CD ROM, a flash memory card, a PROM, a RAM, a ROM, or a magnetic tape. In general, the computer-readable programs may be implemented using any programming language, including C, C++, or JAVA. The software programs may also be stored on or in one or more articles of manufacture as executable code.

What is claimed is:

1. A method for user access to a publicly accessible information source comprising:
providing a publicly accessible information source having data and an integrated visible display, the visible display presenting at least a first subset of the data;
upon viewing the integrated visible display or matching pre-programmed user requirements, sending query data to the publicly accessible information source; and
receiving at least a second subset of the publicly accessible information source data from the publicly accessible information source,
wherein the publicly accessible information source is simultaneously accessible to a plurality of users in the vicinity of the publicly accessible information source.

2. The method of claim 1 wherein the publicly accessible information source sends and receives data using a transceiver.

3. The method of claim 1 wherein the publicly accessible information source performs at least one of storing data, organizing data, and sorting data, using a database.

4. The method of claim 1 further comprising negotiating with the publicly accessible information source to determine the content type of the data received.

5. The method of claim 2 wherein the transceiver communicates using a hardwired connection.

6. The method of claim 2 wherein the transceiver communicates using infrared light.

7. The method of claim 2 wherein the transceiver communicates using radio frequency communications.

8. The method of claim 1 further comprising initiating a telephone call or accessing a URL using the received second subset of data.

9. The method of claim 1 further comprising performing a commercial transaction using the received second subset of data.

10. A method for providing publicly accessible data to a user device comprising:
presenting at least a first subset of publicly accessible data using an integrated visible display;
receiving query data from a user device after the presentation of the first subset of the publicly accessible data;
in response to the query data, sending a second subset of the publicly accessible data to the user device,
wherein the queries of a plurality of users in the vicinity of the presented data are capable of being serviced simultaneously.

11. The method of claim 10 wherein the user device sends and receives data using a transceiver.

12. The method of claim 10 wherein the user device performs at least one of storing data, organizing data, and sorting data, using a database.

13. The method of claim 10 further comprising negotiating with the user device to determine the content type of the sent data.

14. The method of claim 10 further comprising negotiating with the user device to determine the capabilities of the user device.

15. The method of claim 11 wherein the transceiver utilizes a hardwired connection.

16. The method of claim 11 wherein the transceiver utilizes infrared light.

17. The method of claim 11 wherein the transceiver utilizes radio frequency communications.

18. The method of claim 10 wherein the user device is a personal digital assistant.

19. The method of claim 10 wherein the user device is a cellular telephone.

20. The method of claim 10 further comprising initiating a telephone call or access to a URL, by the user device, using the second subset of the data.

21. The method of claim 10 further comprising performing a commercial transaction, by the user device, using the second subset of the data.
